(19) United States
(12) Patent Application Publication
(10) Pub. No.: US 2004/0239974 A1
(43) Pub. Date: Dec. 2, 2004

(54) Print job creation apparatus, job management apparatus, and print job management system including print job creation apparatus and job management apparatus

(76) Inventors: Yasuhiko Uchida, Nagano-ken (JP); Hiroyasu Tamagawa, Nagano-ken (JP); Satoru Momose, Nagano-ken (JP); Kazunori Shimoda, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/799,010

(22) Filed: Mar. 11, 2004

(30) Foreign Application Priority Data
Mar. 12, 2003 (JP) 2003-066821

(51) Int. Cl. G06F 15/00

(52) U.S. Cl. 358/1.14; 358/1.15

(57) ABSTRACT

A print job creation process includes an image registration step by an image registration management module 22, a template selection step by a template setting management module 23, a layout editing step by a layout editing management module 24, and a print step by a print management module 25. A job interruption module 26 interrupts creation of a print job at any stage in the print job creation process and makes ready for creation of a new print job. A job resumption module 27 is activated at a desired timing to resume interrupted creation of a print job. A job output management module 28 is activated to prepare a file of the interrupted print job and send the file to a job management apparatus 40. A print job creation apparatus 20 activates its job input management module 29 to input the file of the interrupted print job from the job management apparatus 40 and make ready for resumption of creation of the interrupted print job.

### BACKGROUND OF THE INVENTION

1. Field of the Invention

The present invention relates to a print job creation apparatus, a job management apparatus, and a print job management system including both the print job creation apparatus and the job management apparatus. More specifically the invention pertains to a print job creation apparatus that creates a print job to print an image, a job management apparatus that manages transmission of a print job under creation via a network connecting with multiple print job creation apparatuses, each of which creates a print job to print an image through plural steps, as well as to a print job management system including these print job creation apparatus and job management apparatus.

2. Description of the Prior Art

Some proposed print job creation apparatuses have been designed to arrange picture images taken with a digital camera in an arbitrary layout and make an album (for example, see ‘Make your original album with photographs of digital camera!’ A. I. Soft Inc., [retrieved on Feb. 15, 2003], the Internet <URN: http://ai2you.com/imaging/products/dpe6ap/dpeas1.asp >). This prior art apparatus creates each print job through three steps, a ‘design selection’ step to sequentially select a desired motif, a desired layout, and a desired mounting of an album, a ‘photograph selection’ step to select images to be printed in the album, and a ‘creation’ step to enter comments and create the respective pages of the album. The user checks a resulting processed album on a display window, prior to actual printing.

These prior art print job creation apparatuses have mainly been developed for the personal use and are not suitable for the business use, for example, at photo studios. For example, a print order may be received from a new customer, while the operator creates a print job in response to an order from another customer. In this case, it is required to interrupt the print job in the middle of its creation. These prior art print job creation apparatuses can not, however, interrupt the print job in the middle of its creation. In the business, a section that receives print orders from customers may be separated from a section that actually executes printing. It is desirable that the order reception section creates a print job to a certain stage based on each customer's requirements and that the print execution section completes creation of the print job and executes the created print job. This requires interruption of a print job in the middle of its creation and transmission of a print job under creation. The prior art print job creation apparatuses do not have such functions.

### SUMMARY OF THE INVENTION

The print job creation apparatus of the invention aims to enable interruption of a print job in the middle of its creation. The print job creation apparatus of the invention also aims to transmit a print job in the middle of its creation to and from another print job creation apparatus. The job management apparatus of the invention aims to manage transmission of print jobs in the middle of their creation between multiple print job creation apparatuses. The object of the invention is also to provide a print job management system that enables print jobs in the middle of their creation to be adequately transmitted between multiple print job creation apparatuses.

In order to achieve at least a part of the aforementioned objects, a print job creation apparatus and a job management apparatus, and print job management system including print job creation apparatus and job management apparatus of the present invention are structured as follows.

A print job creation apparatus of the present invention creates a print job to print an image and the print job creation apparatus includes: an information storage module that stores information; an interruption process module that, in response to an interruption command received in the middle of creation of a print job, stores the print job in the middle of its creation as a print job under creation into the information storage module and makes ready for creation of a new print job; and a resumption process module that, in response to a resumption command to resume interrupted creation of a print job under creation, reads the print job under creation from the information storage module and resumes an original state when the interruption command was received, so as to make ready for continuing creation of the print job under creation.

When receiving an interruption command in the middle of creation of a print job, the print job creation apparatus of the invention stores the print job in the middle of its creation as a print job under creation into the information storage module and makes ready for creation of a new print job. When receiving a resumption command to resume interrupted creation of a print job under creation, the print job creation apparatus of the invention reads the print job under creation from the information storage module and resumes an original state when the interruption command was received, so as to make ready for continuing creation of the print job under creation. This arrangement desirably allows for interruption of a print job in the middle of its creation.

In the print job creation apparatus of the present invention, each print job may be created through multiple steps including an image registration step, a template selection step, and a print instruction step. In this case, the multiple steps may further include a layout editing step between the template selection step and the print instruction step.

In one preferable embodiment of the invention, the print job creation apparatus has a job display module that displays a list of print jobs under creation. This structure desirably notifies the user of the presence of print jobs under creation. The job display module may display details of each print job under creation. This desirably informs the user of the details of each print job under creation. In this embodiment, it is preferable that the print job creation apparatus further includes a comment input module that enters a comment as a piece of information regarding each print job under creation. Here the job display module displays the comment on the print job under creation. This structure receives a comment with regard to each print job under creation and displays the received comment. The comment is effectively used for resumption of interrupted creation of a print job. The job display module may receive the resumption command. The user can thus readily specify a print job under creation as the object of resumption of interrupted creation.

In another preferable embodiment of the invention, the print job creation apparatus further includes a job file output module that, in response to an output instruction including specification of a print job under creation, outputs the specified print job under creation as a job file in a predetermined format. Each print job under creation can thus be output in the form of a file. The file may be sent to a specified destination or may be stored in a portable storage medium for carriage. In the print job creation apparatus of this embodiment, which creates each print job through multiple steps including an image registration step, a template selection step, and a print instruction step, the job file output module outputs a print job under creation, which is at a stage after the template selection step, as a job file. This arrangement is especially effective for the business use to create a print job in response to a print order. Output of a job file of the print job, which has been finished to the certain stage in the print job creation process reflecting the customer's requirements, facilitates the subsequent processing.

In still another preferable embodiment of the invention, the print job creation apparatus further includes a job input module that, in response to a job input instruction including specification of a job file, inputs a print job under creation from the specified job file and stores the input print job under creation into the information storage module. The print job creation apparatus can thus receive a print job in the middle of its creation.

In the print job creation apparatus of the invention, each print job may be created by selecting one print service among multiple print services. Here, the multiple print services include at least one of an enlargement printing service, a digest printing service, a calendar printing service, a postcard printing service, a photo name card printing service, an ID photograph printing service, a seal printing service, a label printing service, and an album printing service.

In one preferable application of the invention, this print job creation apparatus has a duplication process module that, in response to a duplication instruction with specification of a print job under creation, duplicates a registered image corresponding to the specified print job under creation, creates a new print job under creation at a stage of registering the duplicated image, and stores the new print job under creation into the information storage module. This arrangement desirably saves the operator's labor in the case of creation of a new print job using an identical image with that of an existing print job under creation. The print job creation apparatus of this application may further include an execution process module that, in response to an execution instruction with specification of a created print job, stores the contents of the specified print job as an executed print job into the information storage module. In response to a duplication instruction with specification of an executed print job, the duplication process module duplicates a registered image corresponding to the specified executed print job, creates a new print job under creation at a stage of registering the duplicated image, and stores the new print job under creation into the information storage module. This arrangement desirably saves the operator's labor in the case of creation of a new print job using an identical image with that of an existing executed print job. In the print job creation apparatus of this application that includes the duplication process module and creates print jobs of various print services, the duplication process module may create a new print job under creation with respect to a different print service, which is different from a selected print service in the specified print job under creation or executed print job, and store the new print job under creation with respect to the different print service into the information storage module. This arrangement desirably saves the operator's labor in the case of creation of a new print job of a different print service using an identical image with that of an existing print job under creation or that of an existing executed print job.

A print job management system of the present invention includes multiple print job creation apparatuses and a job management apparatus, which are connected via a network, and each of the multiple print job creation apparatuses includes: an information storage module that stores information; an interruption process module that, in response to an interruption command received in the middle of creation of a print job, stores the print job in the middle of its creation as a print job under creation into the information storage module and makes ready for creation of a new print job; a resumption process module that, in response to a resumption command to resume interrupted creation of a print job under creation, reads the print job under creation from the information storage module and resumes an original state when the interruption command was received, so as to make ready for continuing creation of the print job under creation; a transmission process module that, in response to a transmission instruction including transmission destination information and specification of a print job under creation, sends the specified print job under creation as a job file in a predetermined format and the transmission destination information to the job management apparatus; and a reception process module that receives a job file sent from the job management apparatus, inputs a print job under creation from the received job file, and stores the input print job under creation into the information storage module, and the job management apparatus includes: an information storage module that stores information; a job file reception module that receives a job file with transmission destination information sent from one of the multiple print job creation apparatuses and stores the received job file in relation to the transmission destination information into the information storage module; and a job file transmission module that sends a job file stored in the information storage module to a print job creation apparatus, which is specified as a transmission destination by transmission destination information stored in relation to the job file, at a preset timing.

In the print job management system of the invention, when receiving an interruption command in the middle of creation of a print job, the print job creation apparatus stores the print job in the middle of its creation as a print job under creation into the information storage module and makes ready for creation of a new print job. When receiving a resumption command to resume interrupted creation of a print job under creation, the print job creation apparatus reads the print job under creation from the information storage module and resumes an original state when the interruption command was received, so as to make ready for continuing creation of the print job under creation. When receiving a transmission instruction including transmission destination information and specification of a print job under creation, the print job creation apparatus sends the specified print job under creation as a job file in a predetermined format and the transmission destination information to the job management apparatus. When receiving a job file sent from the job management apparatus, the print job creation apparatus inputs a print job under creation from the received job file, and stores the input print job under creation into the information storage module. The print job creation apparatus of this arrangement can send a print job in the middle of its creation as a job file together with transmission destination information to the job management apparatus. The print job creation apparatus of this arrangement can also receive a print job in the middle of its creation as a job file from the job management apparatus for resumption of interrupted creation of the print job. In the print job management system of the invention, the job management apparatus receives a job file with transmission destination information sent from one of the multiple print job creation apparatuses and stores the received job file in relation to the transmission destination information into the information storage module. The job management apparatus also sends a job file stored in the information storage module to a print job creation apparatus, which is specified as a transmission destination by transmission destination information stored in relation to the job file, at a preset timing. The job management apparatus of this arrangement can send a job file received from one of the print job creation apparatuses to another print job creation apparatus specified as the transmission destination at the preset timing. The job management apparatus of this arrangement can also manage transmission of job files between multiple print job creation apparatuses.

In one preferable embodiment of the print job management system of the invention, the preset timing is an output timing of a transmission request of a job file from any one of the multiple print job creation apparatuses via the network. The job file transmission module included in the job management apparatus extracts a job file stored in the information storage module in relation to transmission destination information, which specifies the print job creation apparatus of the request sender as the transmission destination, and sends the extracted job file to the print job creation apparatus of the request sender. The job management apparatus accordingly sends a job file, in response to a transmission request from the specified transmission destination of the job file.

In another preferable embodiment of the print job management system of the invention, the transmission process module included in each of the print job creation apparatuses receives a comment and sends a job file with the received comment to the job management apparatus. The print job creation apparatus adds a comment on creation to a print job in the middle of its creation and sends the print job under creation with the comment to the print job creation apparatus specified as the transmission destination.

In still another preferable embodiment of the print job management system of the invention, each of the multiple print job creation apparatuses creates each print job through multiple steps including an image registration step, a template selection step, and a print instruction step, and the transmission process module included in the each print job creation apparatus sends a print job under creation at a stage after the template selection step to the job management apparatus. This arrangement is especially effective for the business use to create a print job in response to a print order. Output of a job file of the print job, which has been finished to the certain stage in the print job creation process reflecting the customer's requirements, facilitates the subsequent processing.

A job management apparatus of the invention manages transmission of print jobs under creation between multiple print job creation apparatuses via a network, where each of the multiple print job creation apparatuses creates a print job to print an image through multiple steps. The job management apparatus includes:an information storage module that stores information; a job file reception module that receives a job file, which is a file of a print job under creation, with transmission destination information for specifying a print job creation apparatus as a transmission destination from one of the multiple print job creation apparatuses via the network and stores the received job file in relation to the transmission destination information into the information storage module; and a job file transmission module that sends a job file stored in the information storage module to a print job creation apparatus, which is specified as a transmission destination by transmission destination information stored in relation to the job file, at a preset timing.

The job management apparatus of the invention receives a job file, which is a file of a print job under creation, with transmission destination information for specifying a print job creation apparatus as a transmission destination from one of the multiple print job creation apparatuses via the network and stores the received job file in relation to the transmission destination information into the information storage module. The job management apparatus of the invention also sends a job file stored in the information storage module to a print job creation apparatus, which is specified as a transmission destination by transmission destination information stored in relation to the job file, at a preset timing. The job management apparatus of this arrangement can send a job file received from one of the print job creation apparatuses to another print job creation apparatus specified as the transmission destination at the preset timing. The job management apparatus of this arrangement can also manage transmission of job files between multiple print job creation apparatuses.

In one preferable embodiment of the job management apparatus of the invention, the preset timing is an output timing of a transmission request of a job file from any one of the multiple print job creation apparatuses via the network. The job file transmission module extracts a job file stored in the information storage module in relation to transmission destination information, which specifies the print job creation apparatus of the request sender as the transmission destination, and sends the extracted job file to the print job creation apparatus of the request sender. The job management apparatus accordingly sends a job file, in response to a transmission request from the specified transmission destination of the job file.

### BRIEF DESCRIPTION OF THE DRAWINGS

FIG. 1 schematically illustrates the configuration of a print job management system 10;

FIG. 2 shows an example of menu window 60;

FIG. 3 is a flowchart showing a print job creation routine;

FIG. 4 shows an example of image registration window 70;

FIG. 5 shows an example of template selection window 80;

FIG. 6 shows an example of layout editing window 90;

FIG. 7 shows an example of print window 100;

FIG. 8 is a flowchart showing a job interruption routine;

FIG. 9 shows an example of confirmation window 110;

FIG. 10 shows one example of management of print jobs under creation;

FIG. 11 shows a display on the menu window 60;

FIG. 12 shows a display on the menu window 60;

FIG. 13 is a flowchart showing a job resumption routine;

FIG. 14 is a flowchart showing a job output routine;

FIG. 15 shows an example of export management window 130;

FIG. 16 is a flowchart showing a job input routine;

FIG. 17 shows an example of input source selection window 135;

FIG. 18 shows one example of management of print jobs under creation;

FIG. 19 is a flowchart showing a job reception management routine;

FIG. 20 shows the data structure of job management data as an example;

FIG. 21 is a flowchart showing a job transmission management routine;

FIG. 22 is a flowchart showing a job duplication routine;

FIG. 23 shows an example of service selection window 140;

FIG. 24 shows a display on the menu window 60; and

FIG. 25 schematically illustrates the configuration of a print job management system 10B in a modified example.

### DESCRIPTION OF THE PREFERRED EMBODIMENTS

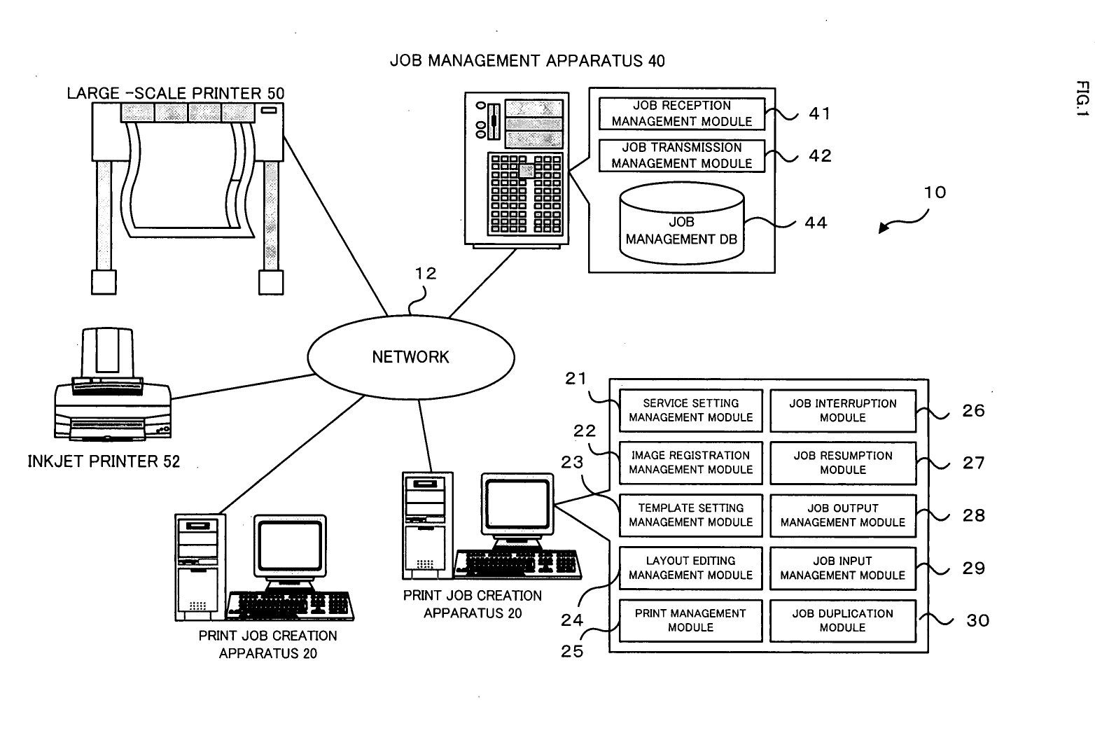

A preferred embodiment of the invention is discussed below. FIG. 1 schematically illustrates the configuration of a print job management system 10 in one embodiment of the invention. The print job management system 10 of the embodiment includes multiple print job creation apparatuses 20 to create print jobs, a job management apparatus 40 to manage print jobs, a large-scale printer 50, and an inkjet printer 52, which are connected via a network 12.

Each of the print job creation apparatuses 20 is constructed as a general computer, in which a non-illustrated print job creation program as application software and support data including template images used for printing are installed. Execution of the print job creation program causes the computer to function as the print job creation apparatus. Each print job creation apparatus 20 creates print jobs as various print services including creation of calendars and creation of postcards and gives instructions of executing such print jobs. As shown in FIG. 1, the print job creation apparatus 20 has, as its functional blocks, a service setting management module 21 that accepts settings of a service selected among various print services to create a print job, an image registration management module 22 that manages registration of one or multiple images used for each print job, a template setting management module 23 that manages settings of a template used for each print job, a layout editing management module 24 that manages adjustment of a layout of images and editing of images, and a print management module 25 that manages printing. The print job creation apparatus 20 also includes a job interruption module 26 that interrupts creation of a print job in the middle, a job resumption module 27 that resumes creation of a print job, which has been interrupted in the middle of its creation (hereafter referred to as print job under creation), a job output management module 28 that manages output of each print job under creation, a job input management module 29 that manages input of each print job under creation, and a job duplication module 30 that duplicates a print job under creation or an executed print job to create a new print job. Due to limitations of space, only two print job creation apparatuses 20 are connected with the network 12 in the illustration of FIG. 1. In the actual state, however, three or more print job creation apparatuses 20 may be connected with the network 12. The detailed operations of the print job creation apparatus will be discussed later.

The job management apparatus 40 is constructed as a management server that receives each print job under creation sent from each of the print job creation apparatuses 20 and sends the print job under creation to another print job creation apparatus 20 specified as a transmission destination of the print job under creation. The job management apparatus 40 includes a job reception management module 41 that manages reception of a print job under creation sent from each of the print job creation apparatuses 20, a job transmission management module 42 that manages transmission of a print job under creation to a print job creation apparatus 20 specified as a transmission destination of the print job under creation, and a job management database 44 that is used for management of reception of print jobs under creation by the job reception management module 41 and for management of transmission of print job under creation by the job transmission management module 42. The detailed operations of the job management apparatus 40 will be discussed later.

The large-scale printer 50 is capable of high-quality color printing to a size A1, while the inkjet printer 52 is capable of high-quality color printing to a size A4. Due to limitations of space, there are only two printers, that is, the large-scale printer 50 and the inkjet printer 52, connected to the network 12 in the illustration of FIG. 1. In the actual state, however, three or more printers of an identical type or different types may be connected to the network 12.

The following describes the operations of the print job management system 10 of the embodiment constructed as discussed above. The description first regards the basic operations of the print job creation apparatus 20 and then the operations of the job management apparatus 40 in connection with those of the print job creation apparatus 20.

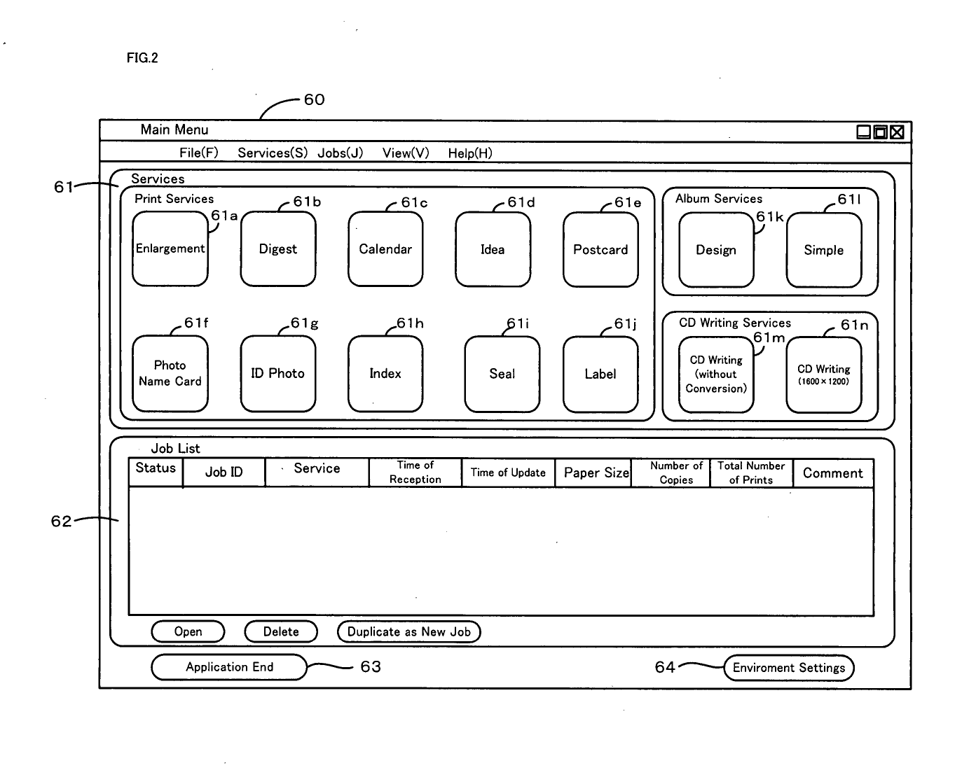

FIG. 2 shows an example of menu window 60 open on the display of the print job creation apparatus 20 on startup of the non-illustrated print job creation program as the application software. The menu window 60 of FIG. 2 has a service selection field 61 for selecting a desired print service and a job list field 62 for displaying a list of print jobs. The service selection field 61 includes various selection buttons for print services, album services, and CD writing services. The buttons for print services include an ‘Enlargement’ button 61a to print an image in a large size, a ‘Digest’ button 61b to print multiple images as a digest, a ‘Calendar’ button 61c to print a calendar with images, an ‘Idea’ button 61d to print an image with any of templates of various designs, a ‘Postcard’ button 61e to print an image on a postcard, a ‘Photo Name Card’ button 61f to print name cards with a photograph, an ‘ID Photo’ button 61g to print an ID photograph, an ‘Index’ button 61h to print an index of a large number of images, a ‘Seal’ button 61i to create seals with an image, and a ‘Label’ button 61j to create labels for CDs and DVDs. The buttons for album services include a ‘Design’ button 61k to create an album with any of templates of various designs and a ‘Simple’ button 611 to create an album with a simple template. The buttons for CD writing services include a ‘CD Writing (without Conversion)’ button 61m to write an image into a CD without any conversion and a ‘CD Writing (1600×1200)’ button 61n to alter the size of an image to 1600×1200 and write the image of the altered size into a CD. The status, the job ID, the selected service, the time of reception, the time of update, the paper size, the number of copies, the total number of prints, and the comment with regard to respective print jobs under creation are listed in the job list field 62. The display of print jobs under creation and the job list field 62 will be discussed later. The menu window 60 also has an ‘Application End’ button 63 and an ‘Environment Settings’ button 64 which are both located below the job list field 62.

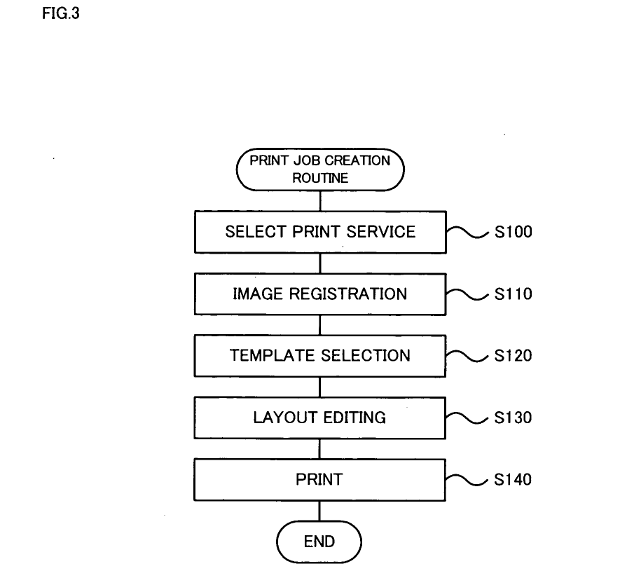

The print job creation apparatus 20 of the embodiment creates a print job according to a print job creation routine shown in FIG. 3. The print job creation routine first receives selection of a desired print service (step S100). The user clicks one of the available service buttons 61a through 61n in the service selection field 61 of the menu window 60 to select a desired print service. The service setting management module 21 of the print job creation apparatus 20 manages display of the menu window 60, acceptance of selection of a service, and start of creation of a print job in the selected service.

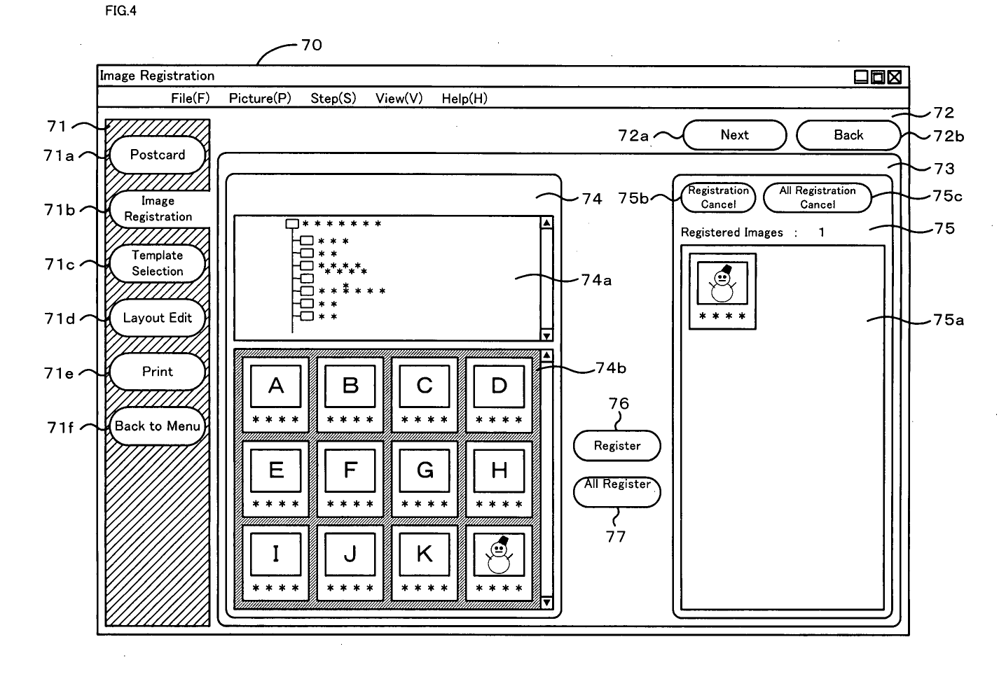

In response to selection of a desired print service, the print job creation apparatus 20 of the embodiment opens an image registration window 70 shown in FIG.4 and executes an image registration step to register images used for the selected print service (step S110). In the illustrated example of FIG. 4, the image registration window 70 has a process display field 71 to display a print job creation process and an image registration dialog box 72 to register selected images. The process display field 71 includes a ‘Selected Service Display’ button 71 to display a selected print service, an ‘Image Registration’ button 71b, a ‘Template Selection’ button 71c, a ‘Layout Edit’ button 71d, and a ‘Print’ button 71e showing steps in the print job creation process, and a ‘Back to Menu’ button 71f to interrupt creation of a current print job and go back to the menu window 60. The image registration dialog box 72 is displayed in connection with the ‘Image Registration’ button 71b and is open when the print job creation process is at the image registration step.

The image registration dialog box 72 has a work field 73, which includes an image selection field 74 to receive the user's selection of a storage place (a directory or a folder), in which images are stored, and display a list of thumbnails and file names of images stored in the selected storage place and a registered image display field 75 to display a list of thumbnails and file names of registered images. The work field 73 also has a ‘Register’ button 76 to register an image selected in the image selection field 74 and display the registered image in the registered image display field 75 and an ‘All Register’ button 77 to register all the images displayed in the image selection field 74 and display all the registered images in the registered image display field 75. The user selects a desired image storage place in a storage place display field. 74a of the image selection field 74, selects a desired image among images displayed in an image display field 74b of the image selection field 74 in response to selection of the storage place (that is, among images stored in the selected storage place), and clicks the ‘Register’ button 76. The desired image is accordingly registered and displayed in an image display field 75a of the registered image display field 75. The registered image display field 75 also has a ‘Registration Cancel’ button 75b to cancel registration of an image selected in the image display field 75a and an ‘All Registration Cancel’ button 75c to cancel registration of all registered images. The image registration dialog box 72 also has a Next’ button 72a to terminate the image registration step and to go to a next step in the print job creation process and a ‘Back’ button 72b to go back to a previous step in the print job creation process. A click of the ‘Back’ button 72b in the image registration window 70 terminates the image registration step and reopens the menu window 60. The ‘Back’ button 72b accordingly has the same function as that of the ‘Back to Menu’ button 71f. The image registration management module 22 of the print job creation apparatus 20 manages this image registration step.

In response to a click of the ‘Next’ button 72a after registration of one or multiple desired images, the print job creation routine opens a template selection window 80 shown in FIG. 5 and executes a template selection step to select a desired template, in which the registered image is inserted (step S120). In the illustrated example of FIG. 5, the template selection window 80 includes a process display field 81, which is identical with the process display field 71 of the image registration window 70 shown in FIG. 4, and a template selection dialog box 82 to select a desired template. In this template selection window 80, the template selection dialog box 82 is displayed in connection with a ‘Template Selection’ button 81c in the process display field 81 and is open when the print job creation process is at the template selection step.

The template selection dialog box 82 has a setting field 83 to specify settings of a template and a template selection field 84 to select a desired template. The setting field 83 includes a layout input box for direct entry of a layout used as a template, a checkbox to set rimless printing, and a checkbox to effectuate image matching of a digital camera with a printer using ‘Print Image Matching 2’ and ‘Exif Print’. The template selection field 84 has tags 85a through 85f corresponding to available template types. The respective tags 85a through 85f have template display fields 86a through 86f to display a list of thumbnails and file names of available templates. The user selects a desired tag among the tags 85a through 85f and selects a desired template among templates displayed in the template display field of the selected tag. In response to selection of the desired template, the selected file name is shown in the layout input box of the setting field 83. The template selection field 84 also has paper size input box to select a desired paper size. The template selection dialog box 82 has a ‘Next’ button 82a to go to a next step and a ‘Back’ button 82b to go back to a previous step, like the image registration dialog box 72. A click of the ‘Back’ button 82b in the template selection window 80 reopens the image registration window 70, and the processing goes back to the previous step, that is, the image registration step (step S110) in the print job creation process. The template setting management module 23 of the print job creation apparatus 20 manages this template selection step.

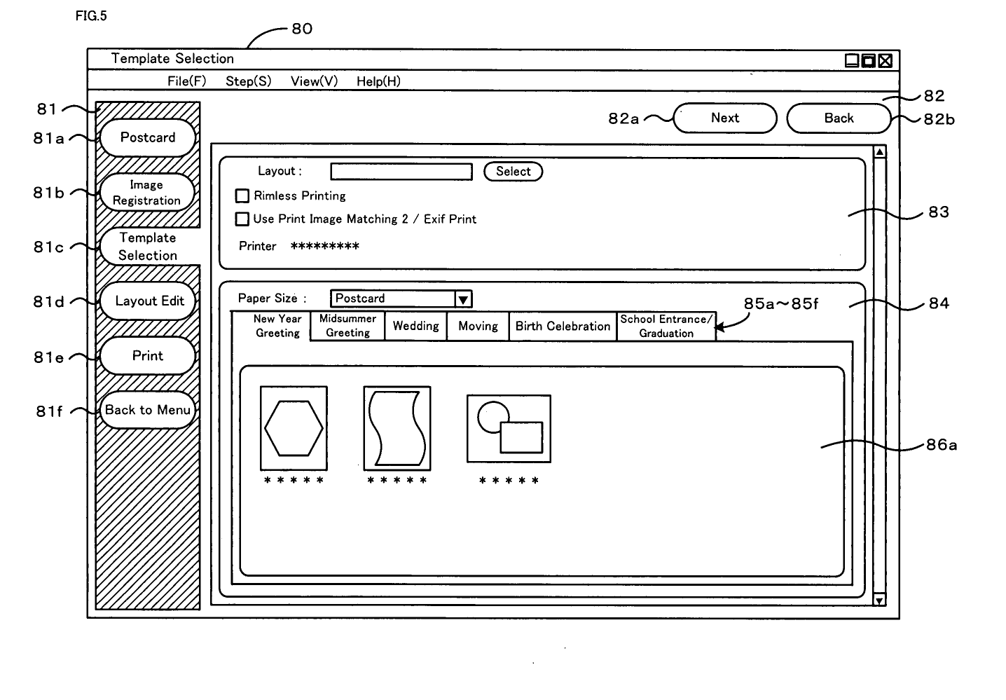

In response to a click of the ‘Next’ button 82a after selection of the desired template, the print job creation routine opens a layout editing window 90 shown in FIG. 6 and executes a layout editing step to adjust a layout of images and edit the images (step S130). In the illustrated example of FIG. 6, the layout editing window 90 includes a process display field 91, which is identical with the process display fields 71 and 81 in the image registration window 70 of FIG. 4 and in the template selection window 80 of FIG. 5, and a layout editing dialog box 92 to layout and edit the images. In this layout editing window 90, the layout editing dialog box 92 is displayed in connection with a ‘Layout Edit’ button 91d in the process display field 91 and is open when the print job creation process is at the layout editing step.

The layout editing dialog box 92 includes a layout editing field 93 to combine the selected template with a registered image and thereby layout and edit the image, an image selection field 94 to select an image to be combined with the selected template, and a thumbnail display field 97 to display the thumbnail of the selected template. The image selection field 94 has a tag 95a for selecting a registered image and a tag 95b for writing a text. The tag 95a has an image display field 96a to display a list of registered images and their file names. The tag 95b has a text input box for entry of a desired text, although not being specifically illustrated. The image selection field 94 also has a ‘Place’ button 94a to place a selected image in the template displayed in the layout editing field 93, a ‘Replace’ button 94b to replace the selected image with an image currently placed in the template in the layout editing field 93, and a ‘Multiple Place’ button 94c to place the selected image in multiple areas of the template. The user may select a desired image among the images displayed in the image display field 96a of the tag 95a and click the ‘Place’ button 94a. This places the selected image in a specified area of the template. The user may select a desired image among the images displayed in the image display field 96a of the tag 95a and click the ‘Replace’ button 94b, while an image has already been placed in a specified area of the template in the layout editing field 93. This replaces the newly selected image with the current image in the specified area of the template. The user may select a desired image among the images displayed in the image display field 96a of the tag 95a and click the ‘Multiple Place’ button 94c. This places the selected image in multiple specified areas of the template. The layout editing dialog box 92 has a ‘Next’ button 92a to go to a next step and a ‘Back’ button 92b to go back to a previous step, like the image registration window 70 and the template selection window 80. The layout editing dialog box 92 also has an ‘Edit’ button 92c to edit the image combined with the template displayed in the layout editing field 93 and a ‘Display Magnification’ button 92d to change a display magnification in the layout editing field 93. When the user selects the image combined with the template displayed in the layout editing field 93 and clicks the ‘Edit’ button 92c, a pulldown menu is open to select a desired specification of editing among various options including rotation, frame rotation, vertical or horizontal inversion, trimming, die cutting, contour softening/sharpening, settings of lightness and contrast, color change, change to sepia/monochromatic, cross filter, red eye reduction, cloning, and auto correction. The output editing management module 24 of the print job creation apparatus 20 manages this layout editing step.

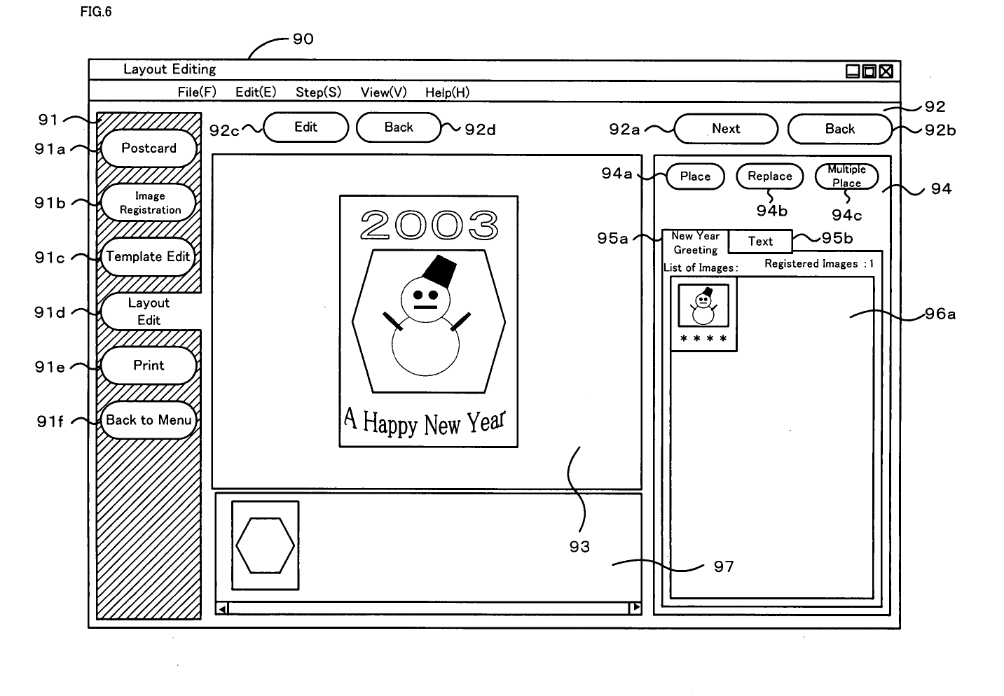

In response to a click of the ‘Next’ button 92a after layout of the image in the selected template and desired editing in the layout editing window 90, the print job creation routine opens a print window 100 shown in FIG. 7 and executes a print step to specify various settings for printing and execute printing (step S140). In the illustrated example of FIG. 7, the print window 100 includes a process display field 101, which is identical with the process display fields 71, 81, and 91 of the image registration window 70, the template selection window 80, and the layout editing window 90, and a print dialog box 102 to specify settings for printing and give a print execution instruction. In this print window 100, the print dialog box 102 is displayed in connection with a ‘Print’ button 101e in the process display field 101 and is open when the print job creation process is at the print step.

The print dialog box 102 has a printed image display field 103 to display a resulting image to be printed, which has been set in the template and gone through layout and editing, a job information display field 104 to display information regarding the print job, a printing condition setting field 105 to set printing conditions, and a printer setting field 106 to specify settings of the printer. The job information display field 104 shows the job ID, the date and time of reception, the service, and the template ID as information regarding the print job, and has a copy number input box to selectively enter a desired number of copies. The printing condition setting field 105 has radio buttons and an input box for setting a print range, radio buttons for setting a print object, and radio buttons for selecting either printing or non-printing of page numbers. The printer setting field 106 has a printer selection box to select a printer to be used for printing, a check box to select either application or non-application of color management system (CMS), and an area input box for setting a printing area. The printer setting field 106 also shows the settings of the paper size and the paper type in the selected printer. The printer selection box in the printer setting field 106 shows the printer set in advance corresponding to the selected combination of the print service and the paper size in the environment settings process as a default printer. The print dialog box 102 also has a ‘Back’ button 102b to go back to a previous step, a ‘Print Start’ button 102c to give a print execution instruction, and a ‘Write’ button 102d to write a resulting image file into a desired directory or folder, instead of printing. The print job creation process executed by the print job creation apparatus 20 of the embodiment terminates in response to a click of the ‘Print Start’ button 102c or in response to a click of the ‘Write’ button 102d. The click of the ‘Print Start’ button 102c or the ‘Write’ button 102d starts execution of the created print job. After execution of printing with the selected printer or writing of a processed image file in response to a click of the ‘Print Start’ button 102c or the ‘Write’ button 102d, the display is returned to the menu window 60 for subsequent selection of a desired print service. The print job creation routine of FIG. 3 terminates at this stage. The print management module 25 of the print job creation apparatus 20 of the embodiment manages this print step.

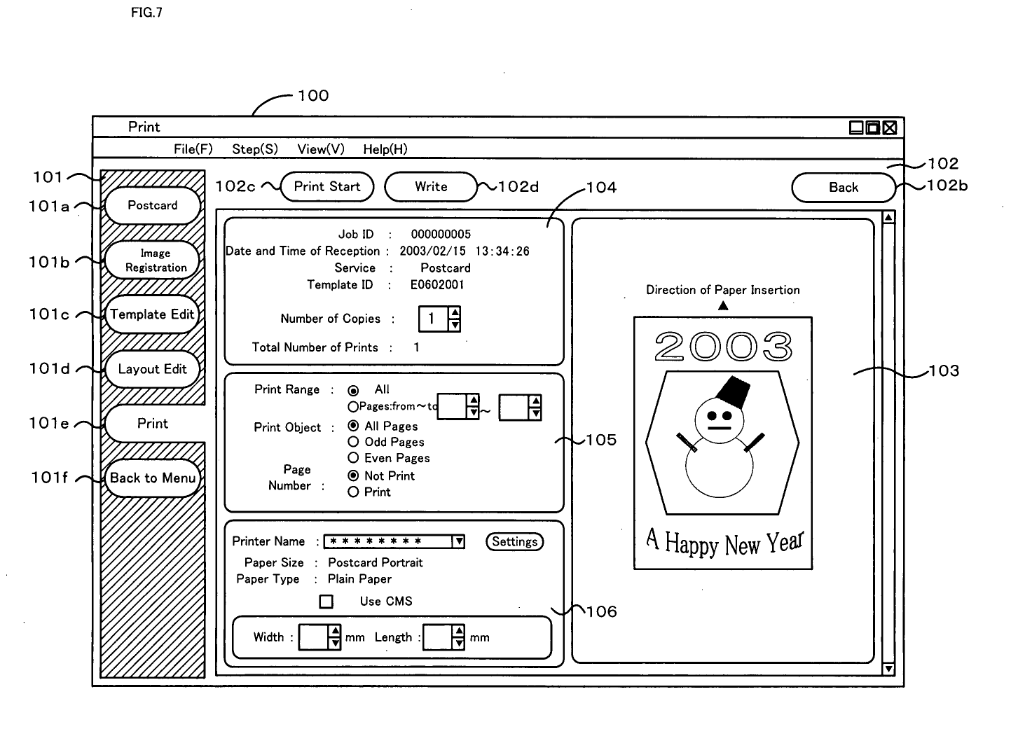

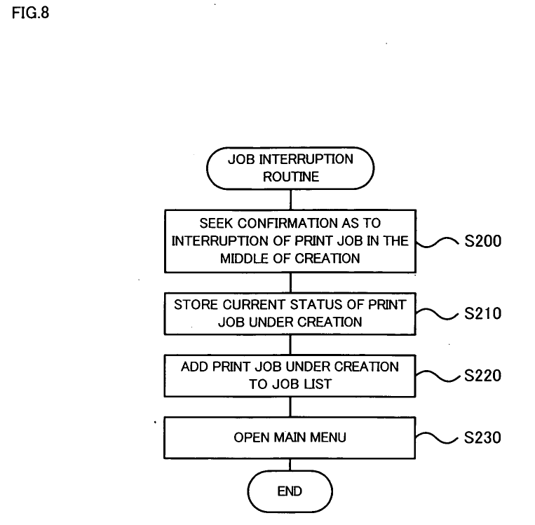

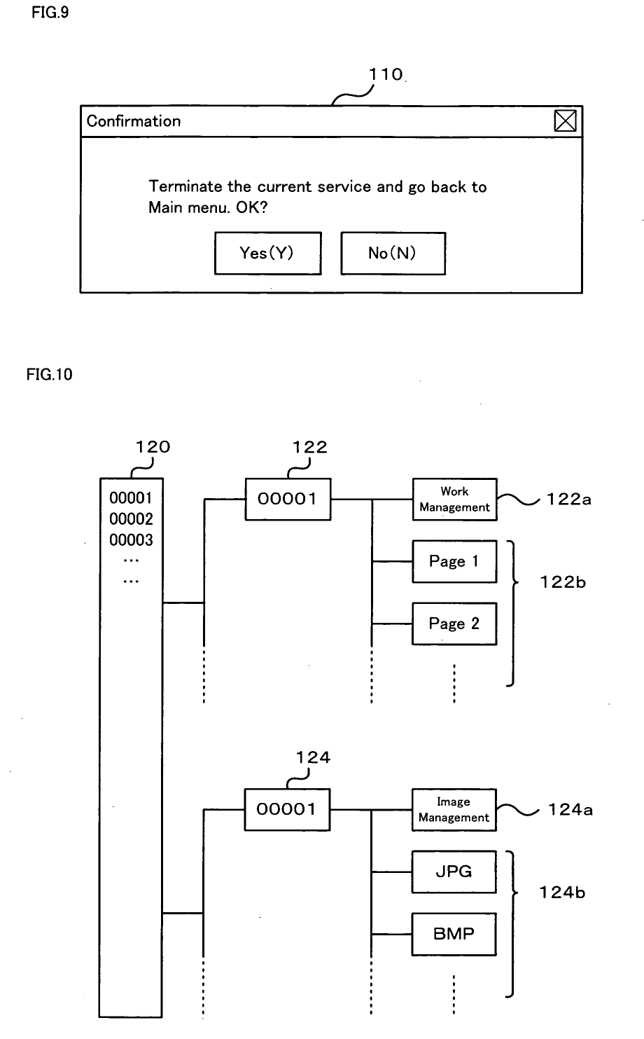

The following describes a series of processing executed in response to a click of any of the ‘Back to Menu’ buttons 71f, 81f, 91f, and 101f in the image registration window 70, the template selection window 80, the layout editing window 90, and the print window 100, that is, a series of processing to interrupt creation of a print job in the middle and go back to the menu window 60. The job interruption module 26 executes this series of processing. FIG. 8 is a flowchart showing a job interruption routine executed in response to a click of any of the ‘Back to Menu’ buttons 71f, 81f, 91f, and 101f provided on the respective windows. When the user clicks any of the ‘Back to Menu’ buttons 71f, 81f, 91f, and 101f in the currently open window during creation of a print job, a confirmation window shown in FIG. 9 opens to seek confirmation as to interruption of a print job (step S200) This confirmation window includes a message notifying the user of interruption of a print job in the middle of its creation, for example, ‘Terminate the current service and go back to Main Menu. OK?’ When the user agrees with interruption of the print job in the middle of its creation, the job interruption module 26 stores the current status of the interrupted print job under creation (step S210), adds the interrupted print job to the job list displayed in the job list field 62 on the menu window 60 (step S220), and opens the menu window 60 (step S230). The display is accordingly returned to the print service selection step (step S100 in the flowchart of FIG. 3) in the print job creation process, where the user can create a new print job.

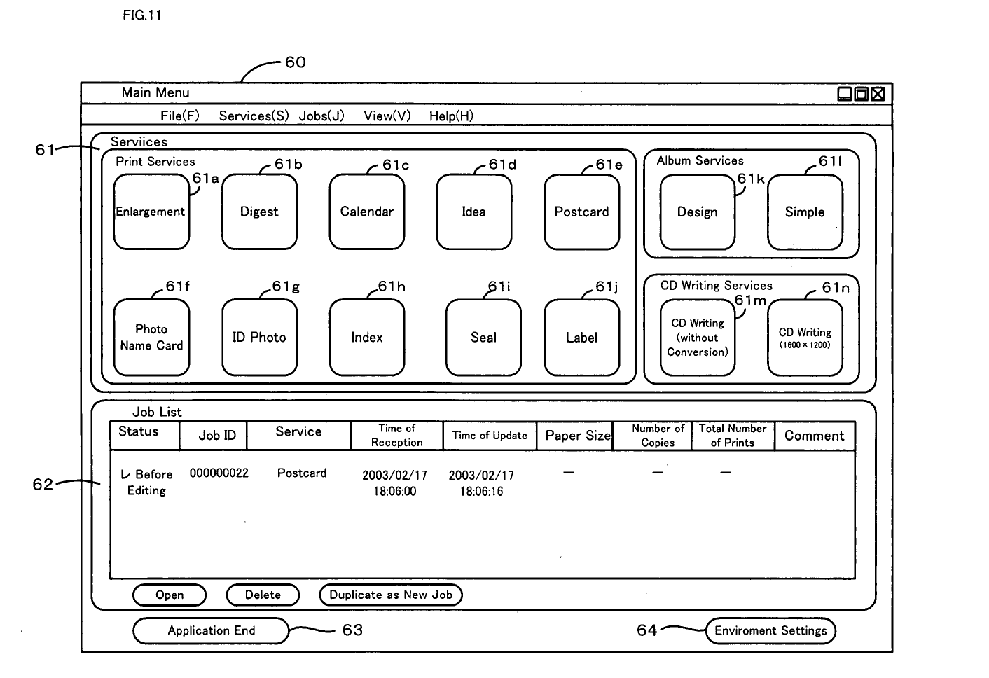

FIG. 10 shows one example of management of print jobs under creation. In response to selection of a desired print service, the management process allocates a job ID to a print job under creation, registers the print job under creation with the job ID in a job management file 120, and creates a management field 122. An image registration field 124 is provided on registration of a desired image in the image registration window 70. The management field 122 has a work management field 122a to store the job status representing the current step in the print job creation process and the file names of respective pages included in the print job under creation and a page storage field 122b to store the respective pages. The page storage field 122b is provided on selection of a desired template, when the concept of pages arises. The image registration field 124 has an image management field 124a to store the file names and the file formats of the respective images and an image storage field 124b to store images classified into file formats. In the print job creation apparatus 20 of the embodiment, the concept of pages does not arise until selection of the template. The page storage field 122b of the management field 122 is thus generated in response to selection of a desired template, that is, when the print job creation process goes to the layout editing step. The processing of step S210 in the job interruption routine of FIG. 8 accordingly stores the current status of the interrupted print job under creation into the work management field 122a, in response to a click of the ‘Back to Menu’ button 71f or 81f in the image registration window 70 or in the template selection window 80 prior to selection of the template. The processing of step S210 stores the current status of the interrupted print job under creation into the work management field 122a and stores the respective pages into the page storage field 122b, on the other hand, in response to a click of the ‘Back to Menu’ button 91f or 101f in the layout editing window 90 or in the print window 100 after selection of the template. FIG. 11 shows a display on the menu window 60 open in response to a click of the ‘Back to Menu’ button 71f or 81f prior to selection of the template. FIG. 12 shows a display on the menu window 60 open in response to a click of the ‘Back to Menu’ button 91f or 101f after selection of the template. As shown in FIGS. 11 and 12, a click of any of the ‘Back to Menu’ buttons 71f, 81f, 91f, and 101f in the currently open window, the print job under creation is added to the job list displayed in the job list field 62 on the menu window 60. The display in the status column of the job list field 62 is ‘Before Editing’ when the ‘Back to Menu’ button 71f or 81f is clicked at the stage prior to selection of the template, while being ‘Under Editing’ when the ‘Back to Menu’ button 91f or 101f is clicked after selection of the template. The display of the status informs the user of the current stage of the print job under creation, that is, the stage before selection of the template or the stage after selection of the template.

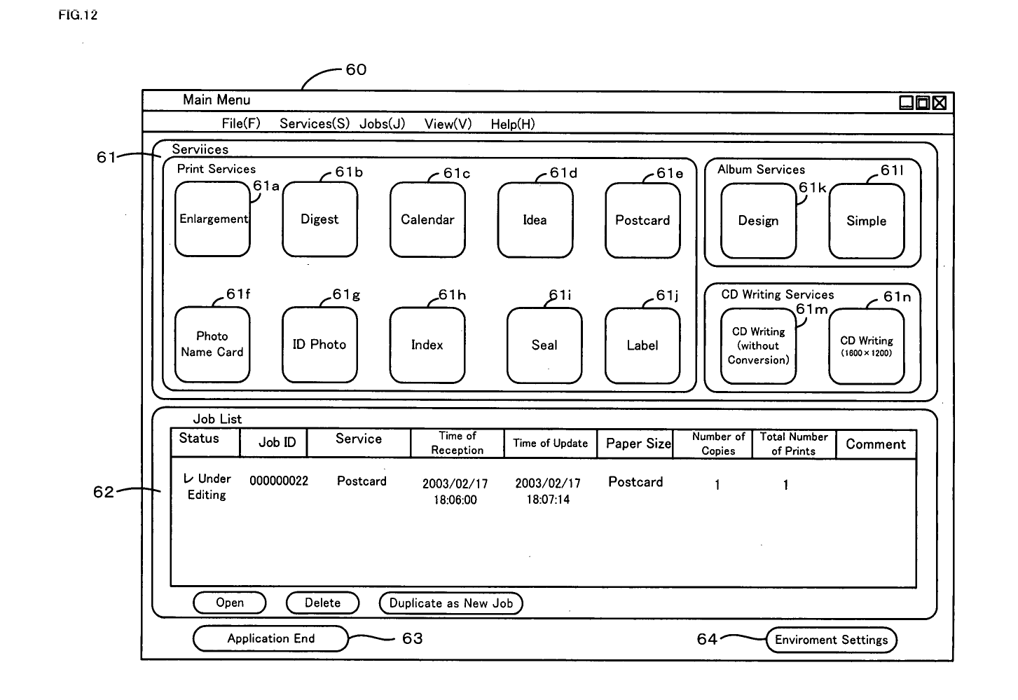

The interrupted creation of a print job is resumed by the job resumption module 27. FIG. 13 is a flowchart showing a job resumption routine executed in response to selection of a print job under creation and output of a resumption command. The selection of an object print job under creation and output of the resumption command are implemented by, for example, double clicking the object print job under creation displayed in the job list field 62. When an object print job under creation is selected in the job list field 62 and a resumption command is output, the job resumption module 27 reads the current status of the object print job under creation from the corresponding work management field 122a based on the job ID allocated to the object print job under creation(step S300), opens a processing window corresponding to the current status of the object print job under creation (step S310), reproduces the object print job under creation with the respective pages stored in the corresponding page storage field 122b (step S320), and resumes interrupted creation of the object print job under creation (step S330). Each print job may be interrupted in the middle of its creation according to the job interruption routine discussed above, while interrupted creation of each print job may be resumed according to the job resumption routine.

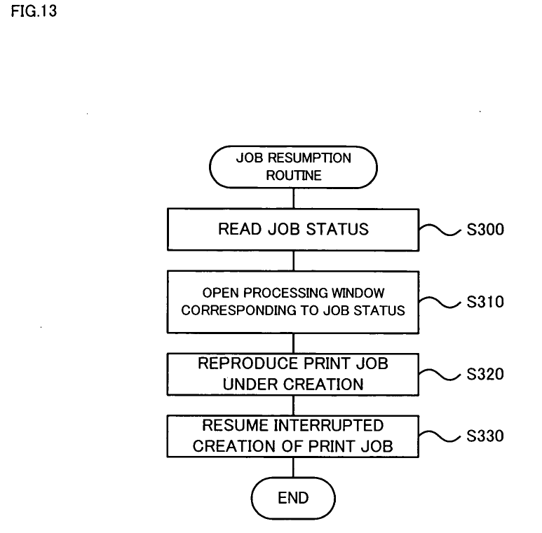

The discussion now regards input and output of each print job under creation. The print job creation apparatus 20 of the embodiment enables the user to select a desired print job under creation in the list displayed in the job list field 62 and output the selected print job under creation in the form of a file to a specified directory or folder or to another print job creation apparatus 20. FIG. 14 is a flowchart showing a job output routine executed to output a selected print job under creation in the form of a file or to send the file to another print job creation apparatus 20. This routine is activated when the user selects a desired print job under creation in the job list field 62 and subsequently selects an option ‘export’ in a pulldown menu, which is open in response to a click of an option ‘Jobs’ on the menu bar. The job output routine first opens an export management window 130 shown in FIG. 15 to receive the user's entries regarding the output destination of a job file, which is a file of the selected print job under creation, the name of the job file, and the comment (step S400). The export management window 130 shown in FIG. 15 has input boxes 131 through 133, where the user enters the output destination of a job file, the name of the job file, and the comment. In the structure of this embodiment, a ‘Settings’ button 134 is provided on the right side of the output destination input box 131. A click of the ‘Settings’ button 134 opens a pulldown menu including available directories and folders. The user may select and enter a desired directory or folder included in the print job creation apparatus 20 as the output destination. The pulldown menu also includes other print job creation apparatuses 20 connected via the network 12 as selectable options. The user is thus allowed to select and enter another print job creation apparatus 20 as the output destination. When the user enters the output destination, the job file name, and the comment in the respective input boxes 131 through 133 on the export management window 130 and clicks an ‘OK’ button, the job output routine prepares a file of a selected print job under creation (step S410) and outputs the file to the selected output destination (step S420). The file of a print job under creation prepared at step S410 includes the contents of the management field 122 corresponding to the print job under creation (see FIG. 10), that is, the contents of the work management field 122a and the page storage field 122b, while not including the contents of the image registration field 124 (that is, the contents of the image management field 124a and the image storage field 124b). When the file of the print job under creation is sent to another print job creation apparatus 20, in many cases, a different user resumes interrupted creation of the print job. The different user often has difficulties in selection of a template and an image to be set in the template. In this embodiment, the subject of the job output routine is accordingly a print job under creation at the stage after selection of the template. In one modification, a print job under creation at the stage prior to selection of the template may be added to the subject of the job output routine. In this modified structure, the file of a print job under creation includes the contents of the image registration field 124, as well as the contents of the management field 122. In the procedure of this embodiment, when another print job creation apparatus 20 is entered in the output destination input box 131 on the export management window 130, a job file accompanied with information regarding specification of the print job creation apparatus 20 as the output destination is sent to the job management apparatus 40. The operations of the job management apparatus 40, which receives the information on the output destination and the job file, will be discussed later. The print job creation apparatus 20 of the embodiment carries out the job output routine to store a print job under creation in the form of a file into a desired directory or folder or to output the file to another print job creation apparatus 20.

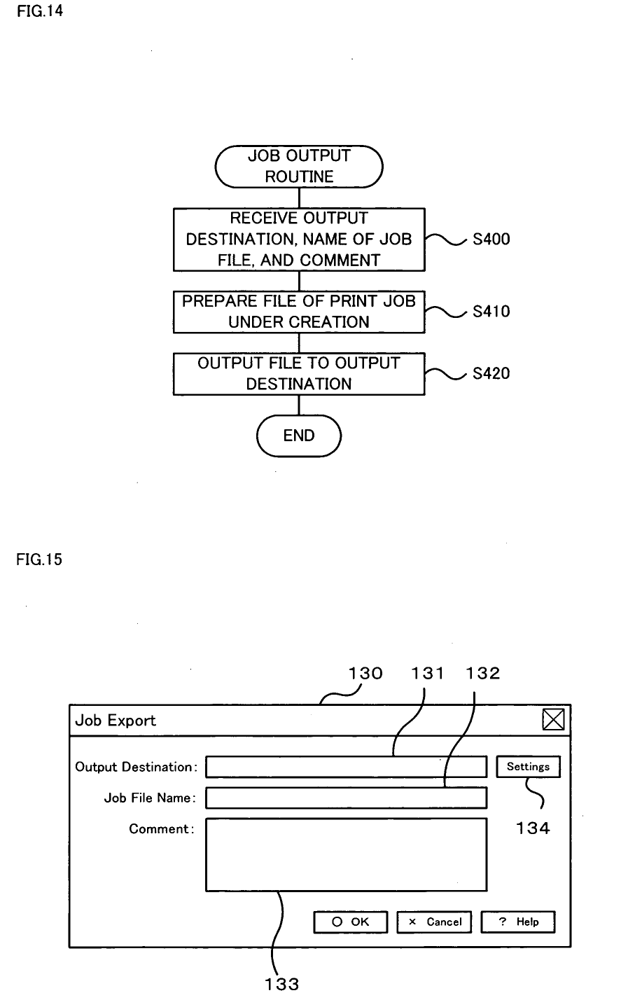

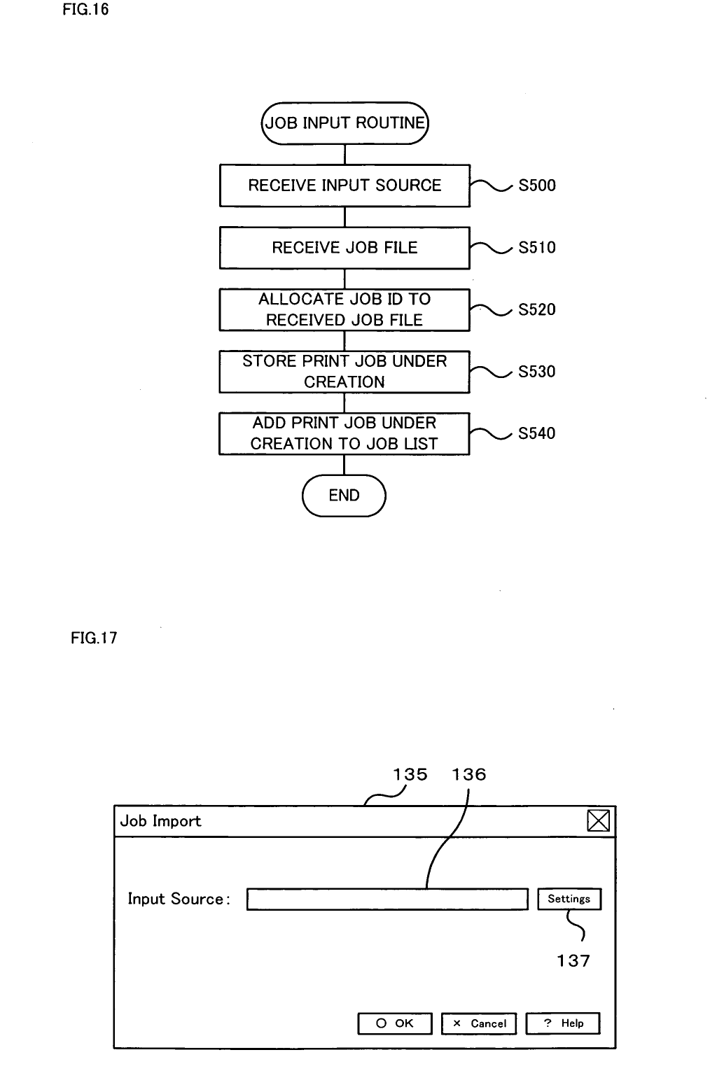

FIG. 16 is a flowchart showing a job input routine executed to input and register a job file in the job list field 62. This routine is activated when the user selects an option ‘import’ in a pulldown menu, which is open in response to a click of the ‘Jobs’ option on the menu bar in the menu window 60. The job input routine first opens an input source selection window 135 shown in FIG. 17 to receive the user's entry regarding the input source of a job file (step S500). The input source selection window 135 shown in FIG. 17 has an input source input box 136, where the user enters the input source. In the structure of this embodiment, a ‘Settings’ button 137 is provided on the right side of the input source input box 136. A click of the ‘Settings’ button 137 opens a pulldown menu including available directories and folders. The user may select and enter a desired directory or folder included in the print job creation apparatus 20 as the input source. The pulldown menu also includes the job management apparatus 40 connected via the network 12 as a selectable option. The user is thus allowed to select and enter the job management apparatus 40 as the input source. When the user enters the input source in the input box 136 and clicks an ‘OK’ button, the job input routine receives a job file and a comment from the specified input source (step S510). When the job management apparatus 40 is specified as the input source, the print job creation apparatus 20 sends a transmission request of the job file to the job management apparatus 40 via the network 12. The job management apparatus 40 sends back the job file and the comment, in response to this transmission request. The job input routine accordingly receives the job file and the comment sent from the job management apparatus 40 at step S510. The operations of the job management apparatus 40 for transmission of the job file will be discussed later.

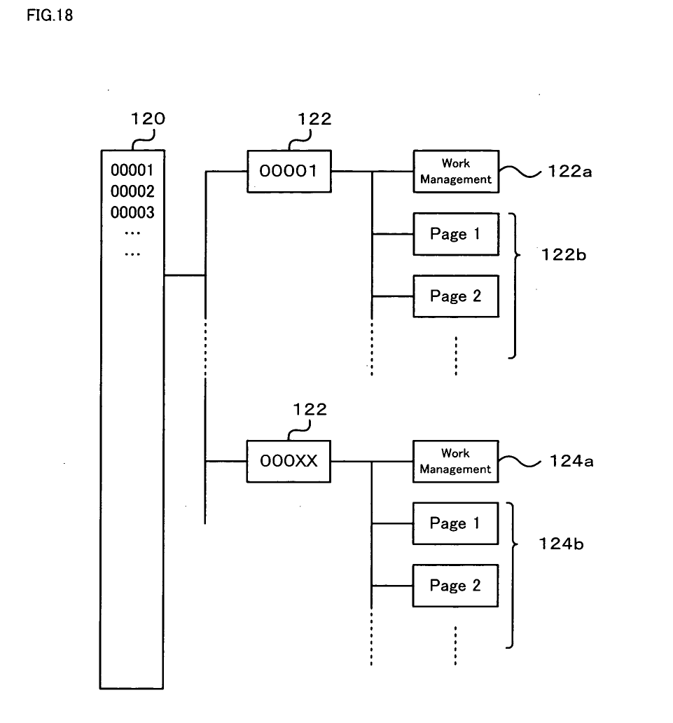

After the input of the job file and the comment, the job input routine allocates a job ID to the input job file in the order of reception (step S520), creates and stores a work management field 122a and a page storage field 122b of a management field 122 corresponding to the input job file as a print job under creation (step S530), and adds the print job under creation to the job list displayed in the job list field 62 (step S540). The input comment is displayed in the comment column in the job list field 62. FIG. 18 shows one example of management of print jobs under creation when a job file is received. In the illustrated example of FIG. 18, the print job creation apparatus 20 receives a job file as a print job under creation, allocates a job ID ‘000XX’ to the received job file, creates a management field 122 including a work management field 122a and a page storage field 122b corresponding to this job ID ‘000XX’, and stores the received print job under creation. As described previously, in this embodiment, the subject of the job output routine is a print job under creation at the stage after selection of the template, and only the contents of the management field 122 in the print job under creation are converted into a file. The job input routine accordingly creates the contents of the management field 122, while not creating the contents of the image registration field 124. In one modification, a print job under creation at the stage prior to selection of the template may be added to the subject of the job output routine. In this modified structure, both the contents of the image registration field 124 and the contents of the management field 122 in the print job under creation are converted into a file. The job input routine then creates both the contents of the management field 122 and the contents of the image registration field 124.

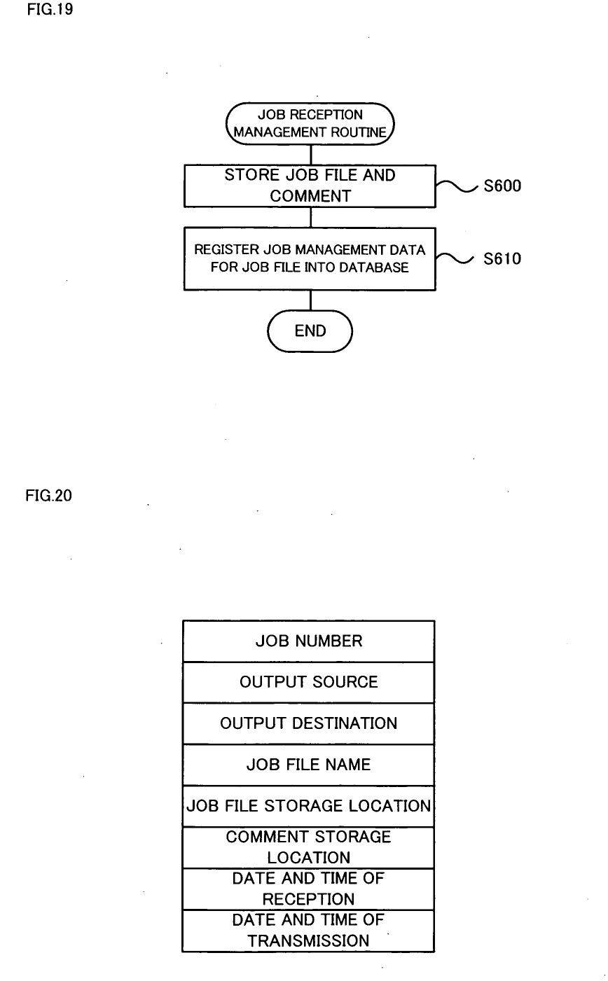

The following describes the operations of the job management apparatus 40. FIG. 19 is a flowchart showing a job reception management routine executed by the job management apparatus 40, when the print job creation apparatus 20 specifies another print job creation apparatus 20 as an output destination in the job output routine and sends a job file to the job management apparatus 40. In the job reception management routine, the job management apparatus 40 receives a job file and a comment sent from the print job creation apparatus 20 of the job sender and stores the job file and the comment into a non-illustrated storage device, such as a hard disk (step S600) and registers job management data for management of the job file into the job management database 44 (step S610). FIG. 20 shows the data structure of the job management data registered in the job management database 44 as an example. The job management data of this example includes the job number assigned in the order of registration, identification of the print job creation apparatus 20 as the output source of the job file, identification of the print job creation apparatus 20 as the output destination of the job file, the name of the job file, the storage location of the job file, the storage location of the comment, the date and time of reception, and the date and time of transmission. The respective data other than the ‘date and time of transmission’ are registered at step S610 in the job reception management routine. The ‘date and time of transmission’ is registered when the job file is actually sent to the print job creation apparatus 20 specified as the output destination as discussed below.

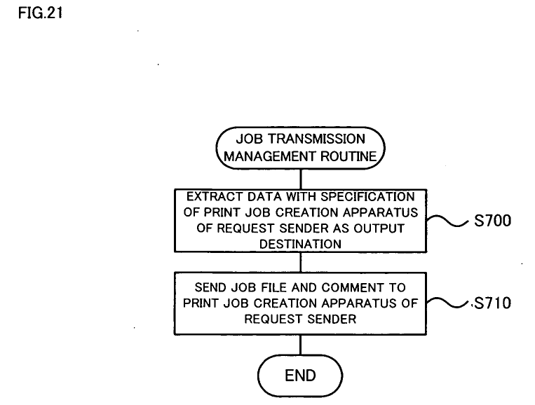

FIG. 21 is a flowchart showing a job transmission management routine executed by the job management apparatus 40 to send a job file to the print job creation apparatus 20 specified as the output destination. This job transmission management routine is activated, in response to a transmission request of the job file sent from the print job creation apparatus 20 specified as the output destination via the network 12. When the job transmission management routine starts, the job management apparatus 40 extracts job management data of a non-transmitted job file from job management data with specification of the print job creation apparatus of the request sender as an output destination stored in the job management database 44 (step S700), reads a job file and a comment from a job file storage location and a comment storage location in the extracted job management data, and sends the job file and the comment to the print job creation apparatus 20 of the request sender (step S710). The operations of the print job creation apparatus 20 receiving the job file and the comment (the job input process) have been discussed previously.

As described above, the job management apparatus 40 of the embodiment receives and stores a job file and a comment specifying an output destination from one print job creation apparatus 20 and sends the job file and the comment, in response to a transmission request from another print job creation apparatus 20 specified as the output destination, to the print job creation apparatus 20 of the request sender. The print job creation apparatus 20 of the job sender can send a print job under creation, regardless of the current status of the print job creation apparatus 20 specified as the output destination. The print job creation apparatus 20 of the job receiver can receive the transmitted print job under creation at a desired timing.

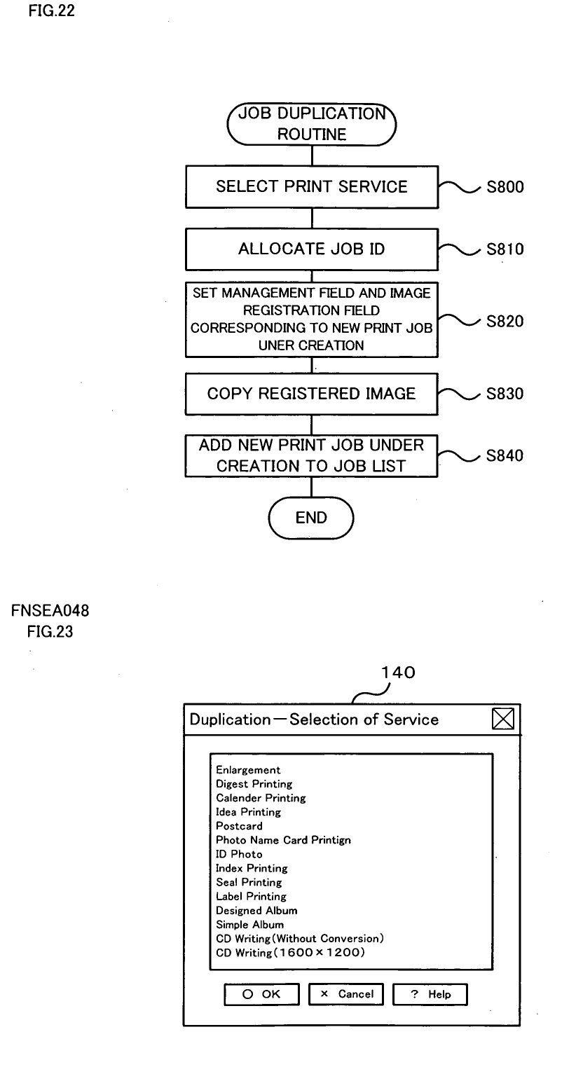

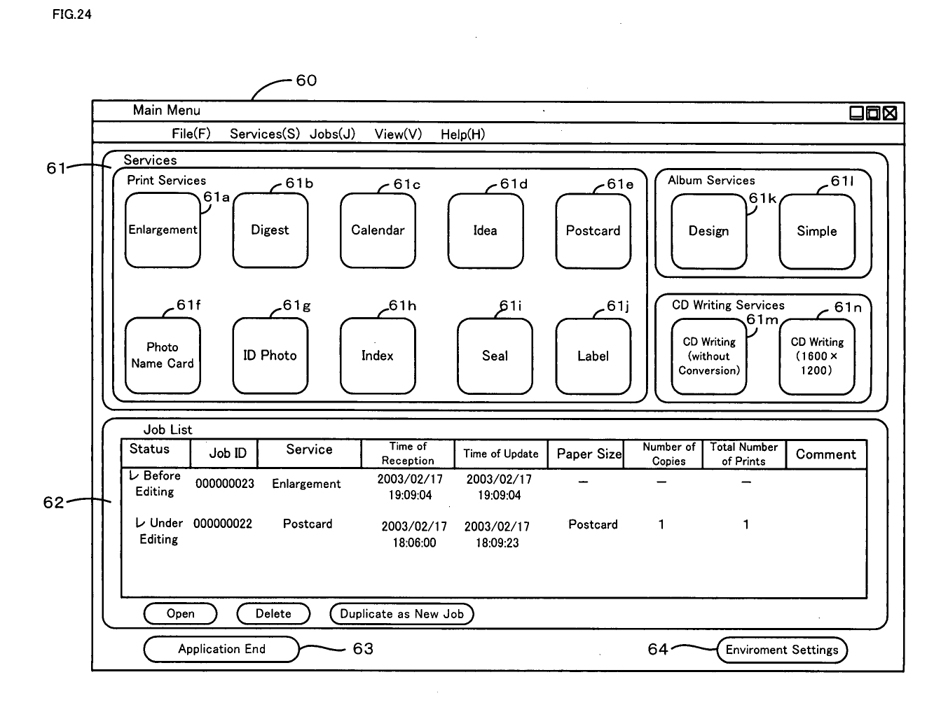

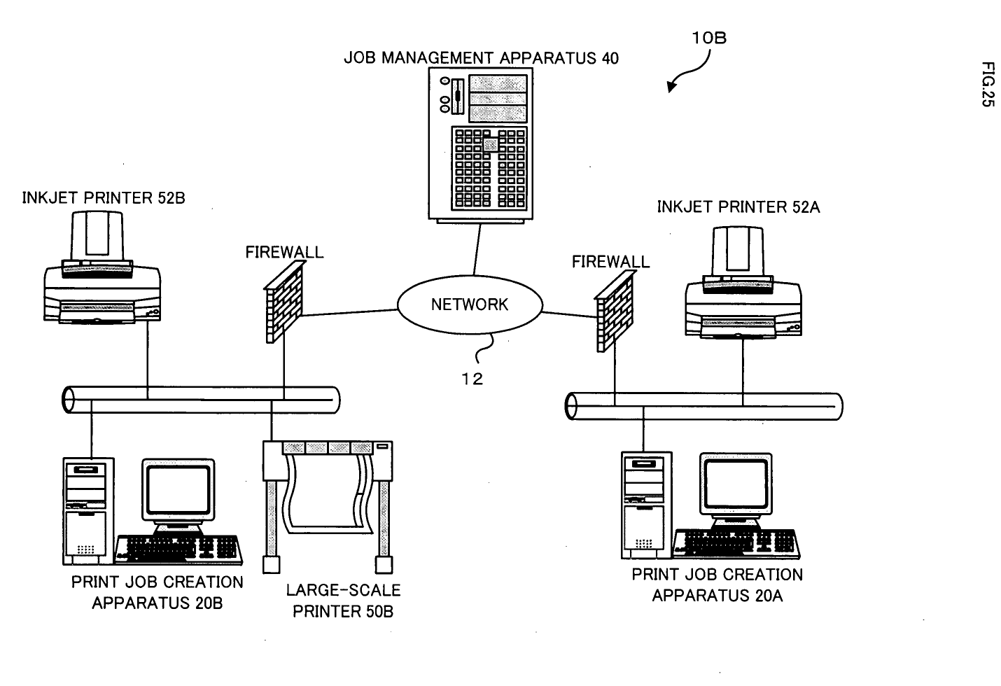

The following description regards a print job duplication process. The print job creation apparatus 20 of the embodiment has the function of duplicating a print job under creation or an executed print job selected out of the list displayed in the job list field 62 to create a new print job of an identical or different print service. FIG. 22 is a flowchart showing a job duplication routine executed by the print job creation apparatus 20 to duplicate a print job under creation or an executed print job. This routine is activated when the user selects a print job under creation or an executed print job in the job list field 62 and subsequently selects an option ‘duplicate’ in a pulldown menu open in response to selection of the option ‘Jobs’ on the menu bar. The job duplication routine first opens a service selection window 140 shown in FIG. 23 to receive the user's selection of a desired print service (step S800). The service selection window 140 of FIG. 23 enables the user to select a desired service among album service options, CD writing service options as well as respective print service options.

When the user selects a desired print service and clicks an ‘OK’ button on the service selection window 140, the print job creation apparatus 20 allocates a job ID (step S810), newly sets a management field 122 and an image registration field 124 corresponding to the allocated job ID, and stores information on the selected print service into a work management field 122a in the newly set management field 122 (step S820). The print job creation apparatus 20 subsequently copies the contents of the image management field 124a and the image storage filed 124b in the image registration field 124 corresponding to a print job under creation or an executed print job selected as the original into the newly set image registration field 124 (step S830) and adds the duplicated print job to the list displayed in the job list field 62 (step S840). In the procedure of this embodiment, duplication of a new print job under creation follows the image registration step. FIG. 24 shows a display on the menu window 60 when a print job under creation with a selected print service ‘Postcard’ displayed in the job list field 62 on the menu window 60 of FIG. 12 is duplicated with selection of a print service ‘Enlargement’. The duplicated print job under creation with the selected print service ‘Enlargement’ is in the image registration step. The ‘status’ is accordingly ‘Before Editing’. The ‘status’ of the executed print job is changed to ‘Completed’.

As discussed above, the print job creation apparatus 20 of the embodiment has the function of interrupting creation of a print job at an arbitrary creation stage and the function of resuming interrupted creation of a print job. These functions enable the operator to successively start creation of new print jobs. This characteristic is especially effective for the business use of image print services.

The print job creation apparatus 20 of the embodiment also has the function of outputting a print job under creation in the form of a file. The file may be sent to the job management apparatus 40 and eventually output to another print job creation apparatus 20. This arrangement enables an operator at the reception desk, in front of a customer, to carry out the process of selecting the customer's desired template and setting one or multiple images in the selected template, while the subsequent editing and printing process is executed by another print job creation apparatus 20 at a location other than the reception desk. Directions for resumption of interrupted creation of a print job may be sent as the comment attached to the file of the print job under creation.

The print job creation apparatus 20 of the embodiment additionally has the function of duplicating a print job under creation or an executed print job to create a new print job of an identical or different print service. This arrangement ensures quick creation of a print job of an identical or different print service. Namely a print job of a desired print service is creatable without the image registration step.

The job management apparatus 40 of the embodiment receives a job file including specification of an output destination from one print job creation apparatus 20, registers the received job file in the job management database 44, and sends the registered job file, in response to a transmission request from another print job creation apparatus 20 specified as the output destination, to the print job creation apparatus 20 of the request sender. The job management apparatus 40 thus effectively manages transmission of job files between multiple print job creation apparatuses 20.

The print job management system 10 including the print job creation apparatus 20 and the job management apparatus 40 of the embodiment efficiently creates a print job and executes the created print job.

The job interruption module 26 and the job resumption module 27 included in the print job creation apparatus 20 of the embodiment respectively correspond to the interruption process module and the resumption process module of the invention. The job output management module 28, the job input management module 29, and the job duplication module 30 respectively correspond to the job file output module, the job input module, and the duplication process module of the invention.

The job reception management module 41, the job transmission management module 42, and the job management database 44 included in the job management apparatus 40 of the embodiment respectively correspond to the job file reception module, the job file transmission module, and the information storage module of the invention.

The print job creation apparatus 20 including the job interruption module 26, the job resumption module 27, the job output management module 28, and the job input management module 29 in the print job management system 10 of the embodiment corresponds to the print job creation apparatus of the invention including the interruption process module, the resumption process module, the transmission process module, and the reception process module. The job management apparatus 40 including the job reception management module 41, the job transmission management module 42, and the job management database 44 corresponds to the job management apparatus of the invention including the job file reception module, the job file transmission module, and the information storage module.

The print job creation apparatus 20 of the embodiment sends a job file and comment to the job management apparatus 40, when another print job creation apparatus 20 is specified as the output destination in the job output routine. In one possible modification, the job file and the comment may be output directly to another print job creation apparatus 20 specified as the output destination via the network 12. In this modified structure, the print job creation apparatus 20 specified as the output destination may carry out the job input routine immediately after reception of the job file, or may store the received job file into a preset directory or folder and later carry out the job input routine.

In the print job management system 10 of the embodiment, the print job creation apparatus 20, the job management apparatus 40, the large-scale printer 50, and the inkjet printer 52 are connected via the network 12. In a print job management system 10B of a modified example shown in FIG. 15, a local network connecting with a print job creation apparatus 20A and an inkjet printer 52A is connected to the network 12 via a firewall, whereas another local network connecting with a print job creation apparatus 20B, a large-scale printer 50B, and an inkjet printer 52B is connected to the network 12 via a firewall. The job management apparatus 40 is also connected to the network 12. This configuration enables job files to be transmitted between the multiple print job creation apparatuses 20 connecting with the different local networks.

The print job creation apparatus 20 of the embodiment enables the user to select a desired print service among the various options, enlargement, digest printing, calendar printing, idea printing, postcard, photo name card, ID photo, index printing, seal printing, and label printing, on the menu window 60. These options of print services are only illustrative and not restrictive in any sense. Part of these print service options may be specified as selectable, or any print service options different from these options may be specified as selectable. These options may otherwise be combined with other print service options.

The print job creation apparatus 20 of the embodiment provides the album services and the CD writing services, in addition to the print services. The album services or the CD writing services may be omitted, when not required. The CD writing services may be replaced by writing services into other storage media, for example, flexible disks, MDs, DVDs, and flash memories.

The print job creation apparatus 20 of the embodiment displays the status, the job ID, the selected service, the time of reception, the time of update, the paper size, the number of copies, the total number of prints, and the comment as the information regarding each print job under creation in the job list field 62. Display of all these pieces of information is only illustrative and is not restrictive in any sense. Part of these pieces of information may be displayed selectively, or any other pieces of information may be displayed instead. The display may otherwise include these pieces of information in combination with other pieces of information.

In the print job creation apparatus 20 of the embodiment, the print job creation process has the four steps, the image registration step, the template selection step, the layout editing step, and the print step, subsequent to selection of a desired print service. This flow of the print job creation process is not restrictive in any sense and may be modified in various ways.

In the print job creation apparatus 20 of the embodiment, interruption of a print job is allowable at any stage in the print job creation process. Interruption of a print job may, however, be allowed at a preset stage in the print job creation process.

The print job creation apparatus 20 of the embodiment carries out the job output routine and the job input routine, although either of the job output routine and the job input routine may be omitted. The print job creation apparatus 20 of the embodiment carries out the job duplication routine, although the job duplication routine may be omitted.

The above description regards the details of the print job creation apparatus 20, the details of the job management apparatus 40, and the details of the print job management system 10 including the print job creation apparatus 20 and the job management apparatus 40 as the embodiment of the invention. Other possible applications of the invention include a program that causes the computer to function as the print job creation apparatus 20 and a program that causes the computer to function as the job management apparatus 40. When the computer functions as the print job creation apparatus 20, the respective steps in the print job creation routine of FIG. 3, those in the job interruption routine of FIG. 8, those in the job resumption routine of FIG. 13, those in the job output routine of FIG. 14, those in the job input routine of FIG. 16, and those in the job duplication routine of FIG. 22 are programmed in an appropriate programming language. When the computer functions as the job management apparatus 40, the respective steps in the job reception management routine of FIG. 19 and those in the job transmission management routine of FIG. 21 are programmed in an appropriate programming language.

The above embodiments are to be considered in all aspects as illustrative and not restrictive. There may be many modifications, changes, and alterations without departing from the scope or sprit of the main characteristics of the present invention. All changes within the meaning and range of equivalency of the claims are therefore intended to be embraced therein.

What is claimed is:

1. A print job creation apparatus that creates a print job to print an image, said print job creation apparatus comprising:
an information storage module that stores information;
an interruption process module that, in response to an interruption command received in the middle of creation of a print job, stores the print job in the middle of its creation as a print job under creation into said information storage module and makes ready for creation of a new print job; and
a resumption process module that, in response to a resumption command to resume interrupted creation of a print job under creation, reads the print job under creation from said information storage module and resumes an original state when the interruption command was received, so as to make ready for continuing creation of the print job under creation.

2. A print job creation apparatus in accordance with claim 1, wherein each print job is created through multiple steps including an image registration step, a template selection step, and a print instruction step.

3. A print job creation apparatus in accordance with claim 2, wherein the multiple steps further include a layout editing step between the template selection step and the print instruction step.

4. A print job creation apparatus in accordance with claim 1, said print job creation apparatus further comprising:
a job display module that displays a list of print jobs under creation.

5. A print job creation apparatus in accordance with claim 4, wherein said job display module displays details of each print job under creation.

6. A print job creation apparatus in accordance with claim 4, said print job creation apparatus further comprising:
a comment input module that enters a comment as a piece of information regarding each print job under creation,
wherein said job display module displays the comment on the print job under creation.

7. A print job creation apparatus in accordance with claim 4, wherein said job display module receives the resumption command.

8. A print job creation apparatus in accordance with claim 1, said print job creation apparatus further comprising:
a job file output module that, in response to an output instruction including specification of a print job under creation, outputs the specified print job under creation as a job file in a predetermined format.

9. A print job creation apparatus in accordance with claim 8, wherein each print job is created through multiple steps including an image registration step, a template selection step, and a print instruction step, and
said job file output module outputs a print job under creation, which is at a stage after the template selection step, as a job file.

10. A print job creation apparatus in accordance with claim 1, said print job creation apparatus further comprising:
a job input module that, in response to a job input instruction including specification of a job file, inputs a print job under creation from the specified job file and stores the input print job under creation into said information storage module.

11. A print job creation apparatus in accordance with claim 1, wherein each print job is created by selecting one print service among multiple print services.

12. A print job creation apparatus in accordance with claim 11, wherein the multiple print services include at least one of an enlargement printing service, a digest printing service, a calendar printing service, a postcard printing service, a photo name card printing service, an ID photograph printing service, a seal printing service, a label printing service, and an album printing service.

13. A print job creation apparatus in accordance with claim 11, said print job creation apparatus further comprising:
a duplication process module that, in response to a duplication instruction with specification of a print job under creation, duplicates a registered image corresponding to the specified print job under creation, creates a new print job under creation at a stage of registering the duplicated image, and stores the new print job under creation into said information storage module.

14. A print job creation apparatus in accordance with claim 13, said print job creation apparatus further comprising:
an execution process module that, in response to an execution instruction with specification of a created print job, stores the contents of the specified print job as an executed print job into said information storage module,
wherein said duplication process module, in response to a duplication instruction with specification of an executed print job, duplicates a registered image corresponding to the specified executed print job, creates a new print job under creation at a stage of registering the duplicated image, and stores the new print job under creation into said information storage module.

15. A print job creation apparatus in accordance with claim 13, wherein said duplication process module creates a new print job under creation with respect to a different print service, which is different from a selected print service in the specified print job under creation or executed print job, and stores the new print job under creation with respect to the different print service into said information storage module.

16. A print job creation apparatus in accordance with claim 1, said print job creation apparatus further comprising:
a duplication process module that, in response to a duplication instruction with specification of a print job under creation, duplicates a registered image corresponding to the specified print job under creation, creates a new print job under creation at a stage of registering the duplicated image, and stores the new print job under creation into said information storage module.

17. A print job creation apparatus in accordance with claim 16, said print job creation apparatus further comprising:
an execution process module that, in response to an execution instruction with specification of a created print job, stores the contents of the specified print job as an executed print job into said information storage module,
wherein said duplication process module, in response to a duplication instruction with specification of an executed print job, duplicates a registered image corresponding to the specified executed print job, creates a new print job under creation at a stage of registering the duplicated image, and stores the new print job under creation into said information storage module.

18. A print job management system comprising multiple print job creation apparatuses and a job management apparatus, which are connected via a network,
each of said multiple print job creation apparatuses comprising: an information storage module that stores information; an interruption process module that, in response to an interruption command received in the middle of creation of a print job, stores the print job in the middle of its creation as a print job under creation into said information storage module and makes ready for creation of a new print job; a resumption process module that, in response to a resumption command to resume interrupted creation of a print job under creation, reads the print job under creation from said information storage module and resumes an original state when the interruption command was received, so as to make ready for continuing creation of the print job under creation; a transmission process module that, in response to a transmission instruction including transmission destination information and specification of a print job under creation, sends the specified print job under creation as a job file in a predetermined format and the transmission destination information to said job management apparatus; and a reception process module that receives a job file sent from said job management apparatus, inputs a print job under creation from the received job file, and stores the input print job under creation into said information storage module,
said job management apparatus comprising: an information storage module that stores information; a job file reception module that receives a job file with transmission destination information sent from one of said multiple print job creation apparatuses and stores the received job file in relation to the transmission destination information into said information storage module; and a job file transmission module that sends a job file stored in said information storage module to a print job creation apparatus, which is specified as a transmission destination by transmission destination information stored in relation to the job file, at a preset timing.

19. A print job management system in accordance with claim 18, wherein the preset timing is an output timing of a transmission request of a job file from any one of said multiple print job creation apparatuses via the network, and
said job file transmission module included in said job management apparatus extracts a job file stored in said information storage module in relation to transmission destination information, which specifies said print job creation apparatus of the request sender as the transmission destination, and sends the extracted job file to said print job creation apparatus of the request sender.

20. A print job management system in accordance with claim 18, wherein said transmission process module included in each of said print job creation apparatuses receives a comment and sends a job file with the received comment to said job management apparatus.

21. A print job management system in accordance with claim 18, wherein each of said multiple print job creation apparatuses creates each print job through multiple steps including an image registration step, a template selection step, and a print instruction step, and
said transmission process module included in said each print job creation apparatus sends a print job under creation at a stage after the template selection step to said job management apparatus.

22. A job management apparatus that manages transmission of print jobs under creation between multiple print job creation apparatuses via a network, where each of said multiple print job creation apparatuses creates a print job to print an image through multiple steps, said job management apparatus comprising:
an information storage module that stores information;
a job file reception module that receives a job file, which is a file of a print job under creation, with transmission destination information for specifying a print job creation apparatus as a transmission destination from one of said multiple print job creation apparatuses via the network and stores the received job file in relation to the transmission destination information into said information storage module; and
a job file transmission module that sends a job file stored in said information storage module to a print job creation apparatus, which is specified as a transmission destination by transmission destination information stored in relation to the job file, at a preset timing.

23. A job management apparatus in accordance with claim 22, wherein the preset timing is an output timing of a transmission request of a job file from any one of said multiple print job creation apparatuses via the network, and
said job file transmission module extracts a job file stored in said information storage module in relation to transmission destination information, which specifies said print job creation apparatus of the request sender as the transmission destination, and sends the extracted job file to said print job creation apparatus of the request sender.
